(19) United States
(12) Patent Application Publication
(10) Pub. No.: US 2013/0132554 A1
(43) Pub. Date: May 23, 2013

(54) METHOD AND DEVICE FOR PROCESSING DATA ON A CONNECTION BETWEEN TWO NODES OF A COMMUNICATION NETWORK

(71) Applicant: Friedrich Armbruster, Muenchen (DE)

(72) Inventor: Friedrich Armbruster, Muenchen (DE)

(73) Assignee: NOKIA SIEMENS NETWORKS OY, ESPOO (FI)

(21) Appl. No.: 13/813,042

(22) PCT Filed: Jul. 29, 2010
(86) PCT No.: PCT/EP10/61033

§ 371 Date: Jan. 29, 2013

(51) Int. Cl. H04L 12/26

(52) U.S. Cl. CPC H04L 43/04
USPC 709/223

(57) ABSTRACT

A method and a device for processing data on a connection between two nodes of a communication network. A first node conveys first data of a first size to a second node. The second node conveys second data of a second size to the first node. The first node determines a first time based on a duration from when the first data is sent until the second data is received. The first node conveys third data of the second size to the second node. The second node conveys fourth data of the first size to the first node. Then the first node determines a second time based on a duration from when the third data is sent until the fourth data is received. A communication system includes at least one such device.

The invention relates to a method and to a device for processing data on a connection between two nodes of a communication network. Also, a communication system comprising at least one such device is suggested.

In packet-oriented communication networks, frequency and/or time require synchronization. In order to provide an accurate time synchronization, it is necessary to determine how long it takes for a packet to travel from a clock source to a clock client.

A Precision Time Protocol (PTP) is known as a high-precision time protocol for synchronization used in measurement and control systems residing on a local area network. Accuracy in the sub-microsecond range may be achieved with low-cost implementations. The PTP was originally defined in the IEEE 1588-2002 standard, officially entitled “Standard for a Precision Clock Synchronization Protocol for Networked Measurement and Control Systems”. In 2008, a revised standard IEEE 1588-2008 was released, which is also known as PTP Version 2 (or “IEEE 1588v2”).

The IEEE 1588 standards describe a hierarchal master-slave architecture for clock distribution purposes. Under this architecture, a time distribution system comprises one or more communication mediums (network segments), and one or more clocks. The ordinary clock is a device with a single network connection and is either the source of (master) or destination for (slave) a synchronization reference. A boundary clock has multiple network connections and can accurately bridge synchronization from one network segment to another. A synchronization master is determined for each of the network segments in the system. A root timing reference is referred to as a grandmaster, which transmits synchronization information to the clocks residing on its network segment. Simplified PTP systems may comprise ordinary clocks connected to a single network (without boundary clocks being used); in such scenario, a grandmaster is determined and all other clocks synchronize directly to it.

IEEE 1588-2008 introduces a clock associated with network equipment used to convey PTP messages. The transparent clock modifies PTP messages as they pass through the device. Timestamps in the messages are corrected for time spent traversing the network equipment. This scheme improves distribution accuracy by compensating delivery variability across the network.

Hence, some efforts have been spent correcting timing information that is embedded into a packet which traverses a network. For example, a time can be measured for a packet to be handled by a node or element of the network. An ingress and/or egress timestamp can be added to the packet or the difference between ingress and egress time stamp (that corresponds to the delay the packet experiences in such node) can be used to correct the original timestamp.

Furthermore, attempts to correct the transmission link delays are made, which work well as long as both directions of a link have the same speed. Then, the involved nodes may measure the Round Trip Time (RTT) of a packet that is conveyed over a link (i.e., the packet travels back and forth via the link) and assume that the one way delay time is half of the RTT.

Unfortunately, this approach does not work with links that provide different bandwidths per direction. In such case, the one way delay cannot be determined to amount to half of the RTT. For example, xDSL lines typically provide a bandwidth in downlink direction (towards the user's modem) that is several times higher than the bandwidth in uplink direction (towards the core network or the provider).

The problem to be solved is to overcome the disadvantages stated before and in particular to provide an efficient solution that allows determining a delay in environments utilizing asymmetric connections or links.

This problem is solved according to the features of the independent claims. Further embodiments result from the depending claims.

In order to overcome this problem, a method for processing data on a connection between a first node and a second node is provided,
wherein the first node conveys first data of a first size to the second node;
wherein the second node conveys second data of a second size to the first node;
wherein the first node determines a first time based on a duration from the first data being sent until the second data is received;
wherein the first node conveys third data of the second size to the second node;
wherein the second node conveys fourth data of the first size to the first node;
wherein the first node determines a second time based on a duration from the third data being sent until the fourth data is received.

It is noted that said data are in particular packets that are conveyed via a packet-oriented network. The first node and the second node may be any component within a network. The first and second node can be directly connected or they may be connected via different components and/or networks. The network may comprise a wireless and/or a wired (fixed) network.

This solution can be used for assessing a connection that comprises an asymmetric link, e.g., different bandwidths in uplink and downlink direction.

In an embodiment, the first time and the second time are round-trip times, for which at least partially handling delays are eliminated.

The round-trip times may be measured using a PTP, e.g., according to an IEEE 1588 standard. Hence, handling delays in the nodes or on the communication path(s) could be eliminated.

In another embodiment, a bandwidth of the link between the first node and the second node is determined.

In a further embodiment, the bandwidth of the link between the first node and the second node is determined as

$${B}_{ab} = \frac{{S}_{2}^{2} - {S}_{1}^{2}}{( {S}_{2} \cdot {RTT}_{2} ) - ( {S}_{1} \cdot {RTT}_{1} )} ,$$

wherein
   B_{ab} denotes the bandwidth of the link between the first node and the second node,
   S₁ denotes the first size of the data,
   S₂ denotes the second size of the data,
   RTT₁ denotes the first time,
   RTT₂ denotes the second time.

In a next embodiment, a bandwidth of the link between the second node and the first node is determined.

It is also an embodiment that the bandwidth of the link between the second node and the first node is determined as

$${B}_{ba} = \frac{{S}_{2}^{2} - {S}_{1}^{2}}{( {S}_{2} \cdot {RTT}_{1} ) - ( {S}_{1} \cdot {RTT}_{2} )} ,$$

wherein
   B_{ba} denotes the bandwidth of the link between the second node and the first node,
   S₁ denotes the first size of the data,
   S₂ denotes the second size of the data,
   RTT₁ denotes the first time,
   RTT₂ denotes the second time.

Pursuant to another embodiment, a delay on the link between the first node and the second node is determined, in particular dependent on the first and/or the second packet size.

According to an embodiment, the delay on the link between the first node and the second node is determined as

$${D}_{1} = \frac{{S}_{1}}{{B}_{ab}} , \\ {D}_{3} = \frac{{S}_{2}}{{B}_{ab}} ,$$

wherein
   D₁ denotes the delay for the first data,
   D₃ denotes the delay for the third data,
   B_{ab} denotes the bandwidth of the link between the first node and the second node,
   S₁ denotes the first size of the data,
   S₂ denotes the second size of the data.

According to another embodiment, a delay on the link between the second node and the first node is determined, in particular dependent on the first and/or the second packet size.

In yet another embodiment, the delay on the link between the second node and the first node is determined as

$${D}_{2} = \frac{{S}_{2}}{{B}_{ba}} , \\ {D}_{4} = \frac{{S}_{1}}{{B}_{ba}} ,$$

wherein
   D₂ denotes the delay for the second data,
   D₄ denotes the delay for the fourth data,
   B_{ba} denotes the bandwidth of the link between the second node and the first node,
   S₁ denotes the first size of the data,
   S₂ denotes the second size of the data.

It is noted that the bandwidths and/or delays may be determined by the first node or any other element of the network; in the latter case, the information required to determined the bandwidths and/or delays can be conveyed to this other element of the network.

Based on such bandwidths and/or delays determined according to the solution presented herein, further adjustments can be provided, e.g., by an operator or a network management entity.

According to a next embodiment, the first size and the second size of data are different.

Advantageously, the first size and the second size may differ at least by a factor of 2.

The problem stated above is also solved by a device comprising or being associated with a processing unit that is arranged such that the method according to any of the preceding claims is executable thereon.

It is noted that the steps of the method stated herein may be executable on this processing unit as well.

The problem can also be solved by a device comprising a processing unit that is arranged for
conveying first data of a first size to a second node;
obtaining second data of a second size from the second node;
determining a first time based on the first data sent and the second data received;
conveying third data of the second size to the second node;
obtaining fourth data of the first size from the second node;
determining a second time based on the third data sent and the fourth data received.

The first and second time determined may each be a RTT determined according to a PTP. The device may be arranged such that a bandwidth towards the second node is determined and/or a bandwidth from the second node to the device is determined. Furthermore, with such bandwidths, the delays for the different data (packets) can be determined.

According to an embodiment, said device is a network element or node of a network, in particular of a packet-oriented network.

It is further noted that said processing unit can comprise at least one, in particular several means that are arranged to execute the steps of the method described herein. The means may be logically or physically separated; in particular several logically separate means could be combined in at least one physical unit.

Said processing unit may comprise at least one of the following: a processor, a microcontroller, a hard-wired circuit, an ASIC, an FPGA, a logic device.

The solution provided herein further comprises a computer program product directly loadable into a memory of a digital computer, comprising software code portions for performing the steps of the method as described herein.

In addition, the problem stated above is solved by a computer-readable medium, e.g., storage of any kind, having computer-executable instructions adapted to cause a computer system to perform the method as described herein.

Furthermore, the problem stated above is solved by a communication system comprising at least one device as described herein.

Embodiments of the invention are shown and illustrated in the following figures:

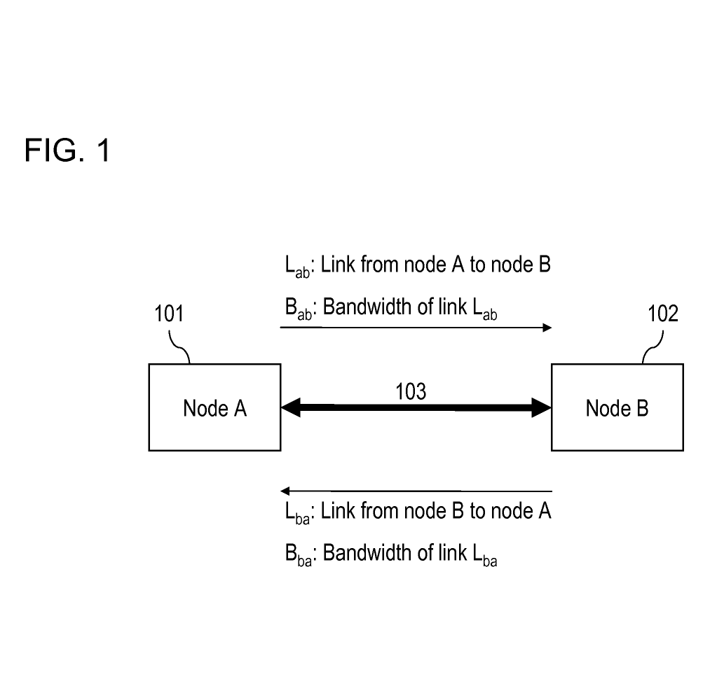

FIG. 1 shows a schematic diagram visualizing two nodes connected via a communication path, which comprises two asymmetric links;

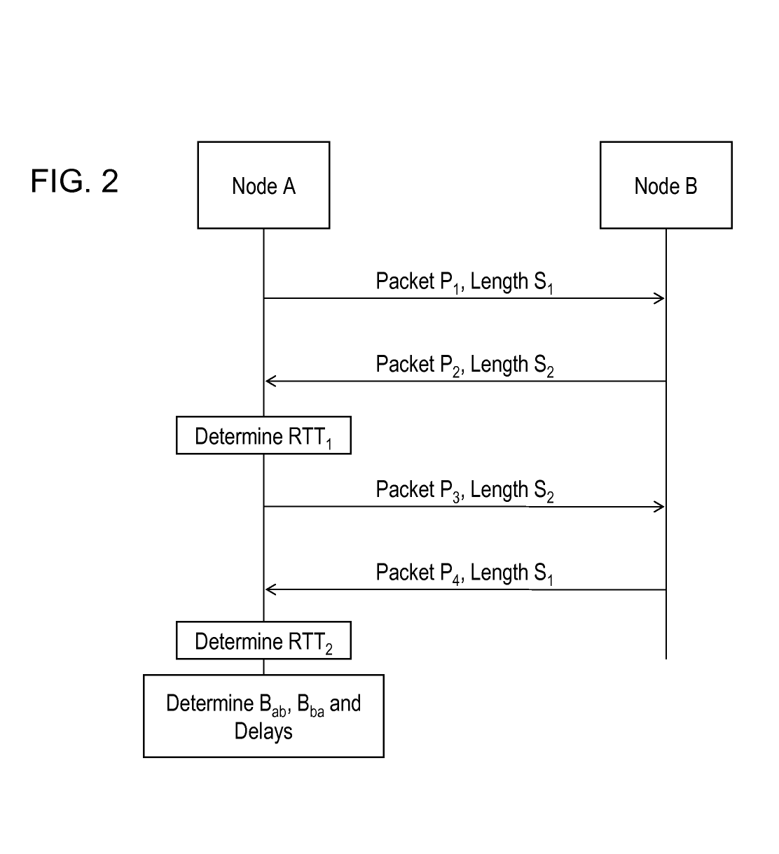

FIG. 2 shows a symbolic message diagram between two nodes of a packet-oriented network visualizing as how bandwidths and delays of a connection with asymmetric links could be determined.

The solution presented allows determining asymmetric delays in a network. This is in particular achieved by sending ping-pong messages of variable size between two ends of the network, measuring a RTT, and then calculating the bandwidth and/or packet delays for each link direction.

FIG. 1 shows a node 101 that is connected to a node 102 via a communication path 103. The node 101 is also referred to as node A and the node 102 is also referred to as node B.

The communication path 103 is capable of conveying packets
from the node A to the node B via a link L_{ab} with a bandwidth B_{ab} and
from the node B to the node A via a link L_{ba} with a bandwidth B_{ba}.

For determining the bandwidths B_{ab} and B_{ba} and thus for determining the delays for the packets of a particular data length, in particular the following steps are suggested (see also FIG. 2):

Step 1:

The node A sends a packet P₁ of a size S₁ to the node B and the node B responds with a packet P₂ of a size S₂. The sizes S₁ and S₂ are different, wherein a small difference may suffice. However, for practical reasons it will be beneficial if the sizes S₁ and S₂ differ at least by a factor of 2.

The node A measures a round-trip time RTT₁ with elimination of handling delays that occur in the node A, on the communication path 103 and the node B (e.g., as described in IEEE 1588v2). Hence, the round-trip time RTT₁ comprises a sum of a link path delay D₁ for the packet P₁ conveyed over the link L_{ab} and of a link path delay D₂ for the packet P₂ conveyed over the link L_{ba}:

RTT₁=D₁+D₂ (1).

Step 2:

The node A sends a packet P₃ of the size S₂ to the node B and the node B responds with a packet P₄ of the size S₁.

The node A measures a round-trip time RTT₂ with elimination of handling delays; thus, the round-trip time RTT₂ comprises a sum of a link path delay D₃ for the packet P₃ conveyed over the link L_{ab} and of a link path delay D₄ for the packet P₄ conveyed over the link L_{ba}:

RTT₂=D₃+D₄ (2).

Hence, the node A can determine the delays that occurred for the packet P₁ sent via the link L_{ab} and for the packet P₄ sent over the link L_{ba}, which both have the same length S₁. Accordingly, the node A can determine the delays for the packets P₂, P₃.

The delays D₁ to D₄ can be determined as follows:

$$\begin{matrix}{D}_{1} = \frac{{S}_{1}}{{B}_{ab}} & ( 3 ) \\ {D}_{2} = \frac{{S}_{2}}{{B}_{ba}} & ( 4 ) \\ {D}_{3} = \frac{{S}_{2}}{{B}_{ab}} & ( 5 ) \\ {D}_{4} = \frac{{S}_{1}}{{B}_{ba}} , & ( 6 )\end{matrix}$$

wherein B_{ab} denotes the bandwidth on the link L_{ab} and B_{ba} denotes the bandwidth on the link L_{ba}.

The equations (3) to (6) can be inserted in equations (1) and (2), which can then be re-written as:

$$\begin{matrix}{B}_{ab} = \frac{{S}_{2}^{2} - {S}_{1}^{2}}{( {S}_{2} \cdot {RTT}_{2} ) - ( {S}_{1} \cdot {RTT}_{1} )} & ( 7 ) \\ {B}_{ba} = \frac{{S}_{2}^{2} - {S}_{1}^{2}}{( {S}_{2} \cdot {RTT}_{1} ) - ( {S}_{1} \cdot {RTT}_{2} )} . & ( 8 )\end{matrix}$$

This allows calculating packet delays as well as bandwidths per link on the node A, which also measures the round-trip times.

### EXAMPLE

As an example, the approach presented can be used to measure the asymmetric bandwidth of a DSL line:

The node A and the node B are connected via a DSL line. The measurements are processed on the node A, the sizes of the packets (packet lengths) amount to

S₁=512 bit;

S₂=1024 bit.

The node B responds to the packets received as described above. The node A determines (measures) the following round-trip times:

RTT₁=2.093 ms;

RTT₂=1.186 ms.

Utilizing equations (7) and (8), the node A determines the following bandwidths:

B_{ab}=5.505 kbit/s;

B_{ba}=512 kbit/s.

The delay can then be determined based on equations (3) to (6):

D₁=0.093 ms;

D₂=2.000 ms;

D₃=0.186 ms;

D₄=1.000 ms

List of Abbreviations:

IEEE Institute of Electrical & Electronics Engineers

PTP Precision Time Protocol

RTT Round-Trip Time

1-14. (canceled)

15. A method for processing data on a connection between a first node and a second node, the method comprising:
conveying first data of a first size from the first node to the second node;
conveying second data of a second size from the second node to the first node;
determining, with the first node, a first time based on a duration from when the first data are sent until the second data are received;
conveying third data of the second size from the first node to the second node;
conveying fourth data of the first size from the second node to the first node; and
determining, with the first node, a second time based on a duration from when the third data are sent until the fourth data are received.

16. The method according to claim 15, wherein the first time and the second time are round-trip times, for which at least partially handling delays are eliminated.

17. The method according to claim 15, which comprises determining a bandwidth of a link between the first node and the second node.

18. The method according to claim 17, wherein the step of determining the bandwidth of the link between the first and second nodes comprises solving the following:
$${B}_{ab} = \frac{{S}_{2}^{2} - {S}_{1}^{2}}{( {S}_{2} \cdot {RTT}_{2} ) - ( {S}_{1} \cdot {RTT}_{1} )}$$
wherein
B_{ab} denotes the bandwidth of the link from the first node to the second node;
S₁ denotes the first size of the data;
S₂ denotes the second size of the data;
RTT₁ denotes the first time; and
RTT₂ denotes the second time.

19. The method according to claim 15, which comprises determining a bandwidth of the link between the second node and the first node.

20. The method according to claim 19, wherein the step of determining the bandwidth of the link between the second node and the first node comprises solving the following:
$${B}_{ba} = \frac{{S}_{2}^{2} - {S}_{1}^{2}}{( {S}_{2} \cdot {RTT}_{2} ) - ( {S}_{1} \cdot {RTT}_{1} )} ,$$
wherein
B_{ba} denotes the bandwidth of the link from the second node to the first node;
S₁ denotes the first size of the data;
S₂ denotes the second size of the data;
RTT₁ denotes the first time; and
RTT₂ denotes the second time.

21. The method according to claim 15, which comprises determining a delay on the link between the first node and the second node.

22. The method according to claim 21, wherein the delay is determined in dependence on a first and/or a second packet size.

23. The method according to claim 21, wherein the delay on the link between the first node and the second node is determined as follows:
$${D}_{1} = \frac{{S}_{1}}{{B}_{ab}} , \\ {D}_{3} = \frac{{S}_{2}}{{B}_{ab}} ,$$
wherein
D₁ denotes the delay for the first data;
D₃ denotes the delay for the third data;
B_{ab} denotes a bandwidth of the link between the first node and the second node;
S₁ denotes the first size of the data; and
S₂ denotes the second size of the data.

24. The method according to claim 15, which comprises determining a delay on the link between the second node and the first node.

25. The method according to claim 24, wherein the delay is determined in dependence on a first and/or a second packet size.

26. The method according to claim 23, wherein the delay on the link between the second node and the first node is determined as follows:
$${D}_{2} = \frac{{S}_{2}}{{B}_{ba}} , \\ {D}_{4} = \frac{{S}_{1}}{{B}_{ba}}$$
wherein
D₂ denotes the delay for the second data;
D₄ denotes the delay for the fourth data;
B_{ba} denotes a bandwidth of the link between the second node and the first node;
S₁ denotes the first size of the data; and
S₂ denotes the second size of the data.

27. The method according to claim 15, wherein the first size of the data and the second size of the data are mutually different.

28. A device, comprising: a processing unit configured to execute thereon the method according to claim 15.

29. The device according to claim 28, configured as a network element or a node of a network.

30. The device according to claim 29, configured as an element or a node of a packet-oriented network.

31. A communication system, comprising at least one device having a processing unit configured to execute thereon the method according to claim 15.
